(19) United States
(12) Patent Application Publication
(10) Pub. No.: US 2017/0284203 A1
(43) Pub. Date: Oct. 5, 2017

(54) TURBO ROTOR AND MANUFACTURING METHOD OF TURBO ROTOR

(71) Applicant: NOPORVIS CO., LTD., Kaohsiung City (TW)

(72) Inventors: Chun-Neng Chan, Kaohsiung City (TW); Kuo-Kai Hung, Tainan City (TW); Hui-Hung Lin, Tainan City (TW)

(21) Appl. No.: 15/180,075

(22) Filed: Jun. 12, 2016

(30) Foreign Application Priority Data
Apr. 1, 2016 (TW) 105110552

(51) Int. Cl. F01D 5/04; F01D 5/02

(52) U.S. Cl. CPC F01D 5/048; F01D 5/025; F05D 2220/40; F05D 2230/21; F05D 2230/233; F05D 2260/30

(57) ABSTRACT

A turbo rotor includes a turbine wheel, a connection element and a rotor shaft. The turbine wheel has a plurality of blades, wherein a cavity is formed at a bottom of the turbine wheel, and at least one fixing structure is formed in the cavity. The connection element is accommodated in the cavity. The connection element includes a main body and at least one engaging structure formed on the main body, wherein the at least one engaging structure is engaged with the at least one fixing structure for preventing the connection element from moving along or rotating around a rotational axis of the turbo rotor relative to the turbine wheel. The rotor shaft is connected to the main body for supporting the turbine wheel.

### BACKGROUND OF THE INVENTION

### 1. Field of the Invention

The present invention relates to a turbo rotor and a manufacturing method of a turbo rotor, and more particularly, to a turbo rotor and a manufacturing method of a turbo rotor capable of increasing flexibility in material selection and product stability.

### 2. Description of the Prior Art

Generally, a turbo charger utilizes gas discharged from an internal combustion engine to drive a turbo rotor of the turbo charger to rotate, and the turbo rotor further boosts pressure of air in an intake passage of the internal combustion engine, so as to improve efficiency of the internal combustion engine. The turbo rotor of the turbo charger mainly comprises a turbine wheel and a rotor shaft. Since the turbine wheel and the rotor shaft are made of different materials, the rotor shaft is usually welded to the turbine wheel through a welding material. For example, the turbine wheel can be made of titanium, and the rotor shaft can be made of carbon steel. In order to weld the rotor shaft to the turbine wheel, a welding material able to be welded to titanium and carbon steel is required. However, there are few selections for the above welding material. Moreover, when strength or bonding force of the welding material is not enough, a jointing area between the turbine wheel and the rotor shaft is easy to break. Therefore, the turbo rotor of the prior art has less flexibility in material selection and product stability.

### SUMMARY OF THE INVENTION

The present invention provides a turbo rotor comprising a turbine wheel, a connection element and a rotor shaft. The turbine wheel has a plurality of blades, wherein a cavity is formed at a bottom of the turbine wheel, and at least one fixing structure is formed in the cavity. The connection element is accommodated in the cavity. The connection element comprises a main body and at least one engaging structure formed on the main body, wherein the at least one engaging structure is engaged with the at least one fixing structure for preventing the connection element from moving along or rotating around a rotational axis of the turbo rotor relative to the turbine wheel. The rotor shaft is connected to the main body for supporting the turbine wheel.

The present invention further provides a manufacturing method of a turbo rotor, comprising forming a connection element comprising a main body and at least one engaging structure formed on the main body; forming a turbine wheel having a plurality of blades, wherein a cavity is formed at a bottom of the turbine wheel for accommodating the connection element, at least one fixing structure is formed in the cavity, the at least one engaging structure is engaged with the at least one fixing structure for preventing the connection element from moving along or rotating around a rotational axis of the turbo rotor relative to the turbine wheel; and welding a rotor shaft to the main body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a turbo rotor of the present invention.

FIG. 2 is an exploded view of the turbo rotor of the present invention.

FIG. 3 is a cross-sectional view of the turbo rotor of the present invention.

FIG. 4 is a cross-sectional view of components of the turbo rotor of the present invention.

FIG. 5 is a cross-sectional view of combination of a turbine wheel and a connection element.

FIG. 6 is a diagram illustrating a manufacturing method of the turbo rotor of the present invention.

FIG. 7 is a diagram illustrating a welding process of the turbo rotor according to a first embodiment of the present invention.

FIG. 8 is a diagram illustrating a welding process of the turbo rotor according to a second embodiment of the present invention.

FIG. 9 is a flowchart showing the manufacturing method of the turbo rotor of the present invention.

### DETAILED DESCRIPTION

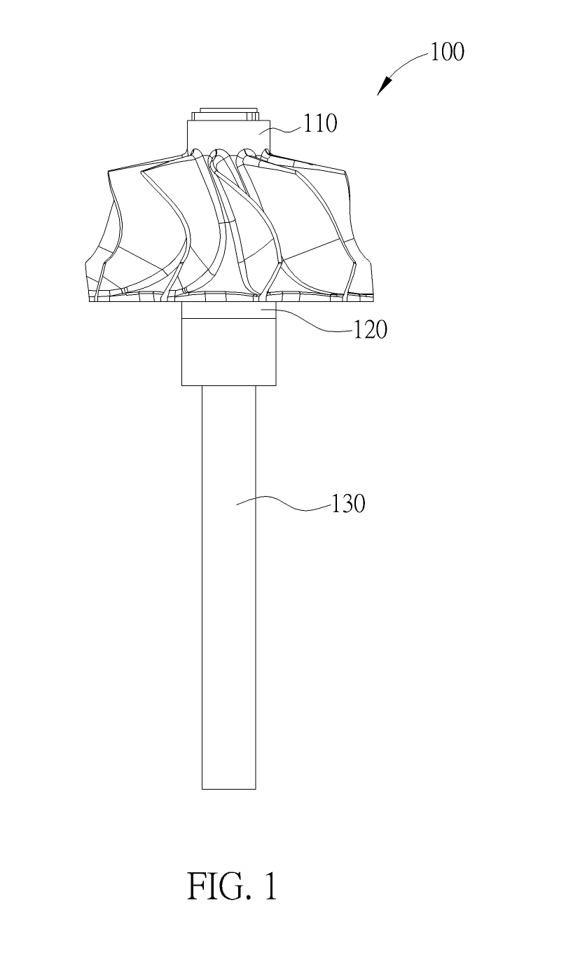

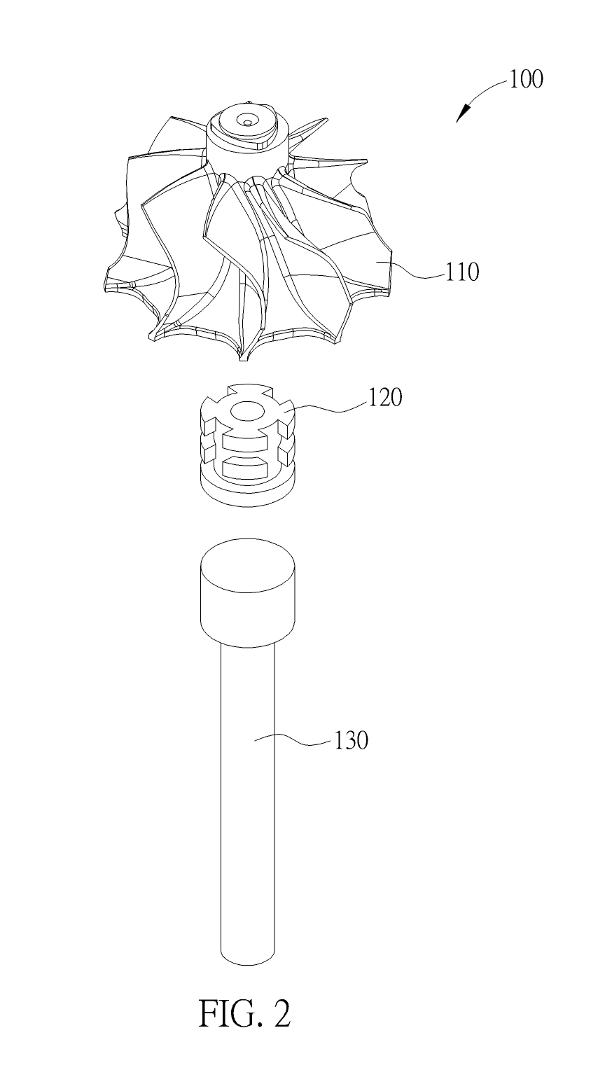

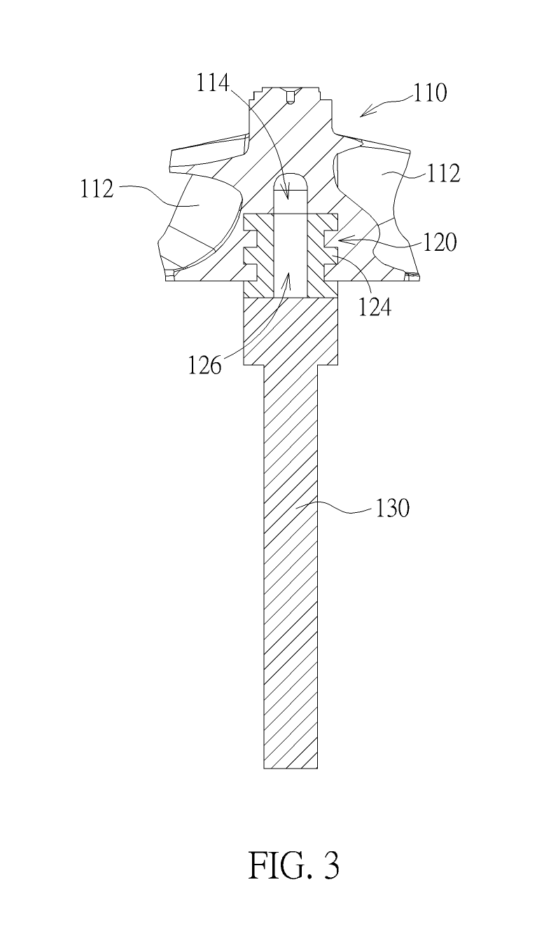

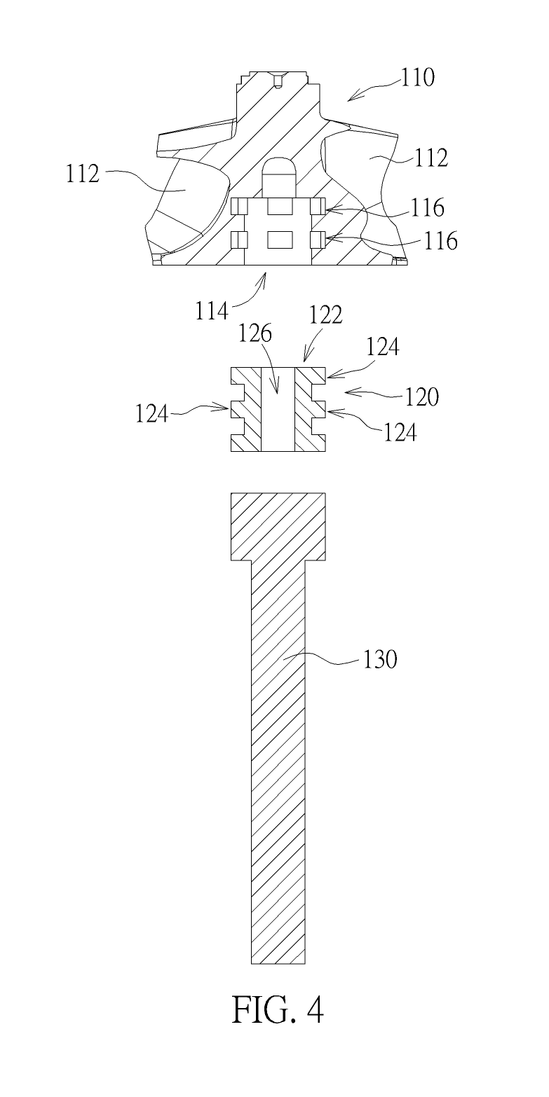

Please refer to FIG. 1 to FIG. 4. FIG. 1 is a diagram showing a turbo rotor of the present invention. FIG. 2 is an exploded view of the turbo rotor of the present invention. FIG. 3 is a cross-sectional view of the turbo rotor of the present invention. FIG. 4 is a cross-sectional view of components of the turbo rotor of the present invention. As shown in figures, the turbo rotor 100 of the present invention comprises a turbine wheel 110, a connection element 120 and a rotor shaft 130. The turbine wheel 110 has a plurality of blades 112, wherein a cavity 114 is formed at a bottom of the turbine wheel and a plurality of fixing structures 116 is formed in the cavity 114. The connection element 120 is accommodated in the cavity 114. The connection element 120 comprises a main body 122 and a plurality of engaging structures 124 formed on the main body 122. A shape of the engaging structure 124 of the connection element 120 corresponds to a shape of the fixing structure 116 of the turbine wheel 110, such that the engaging structure 124 of the connection element 120 can be engaged with the fixing structure 116 of the turbine wheel 110. The rotor shaft 130 is connected to the main body 122 of the connection element 120 for supporting the turbine wheel 110 through the connection element 120.

In addition, in the present embodiment, the engaging structure 124 of the connection element 120 is protruded from the main body 122, and the fixing structure 116 of the turbine wheel 110 is recessed from a surface of the cavity 114, such that the engaging structure 124 of the connection element 120 can be engaged with the fixing structure 116 of the turbine wheel 110. However, the present invention is not limited thereto. In other embodiment of the present invention, the engaging structure of the connection element 120 can be recessed from a surface of the main body 122, and the fixing structure of the turbine wheel 110 can be protruded from the surface of the cavity 114; or, the engaging structures of the connection element 120 can be protruded structures and recessed structures, and the fixing structures of the turbine wheel 110 can also be protruded structures and recessed structures.

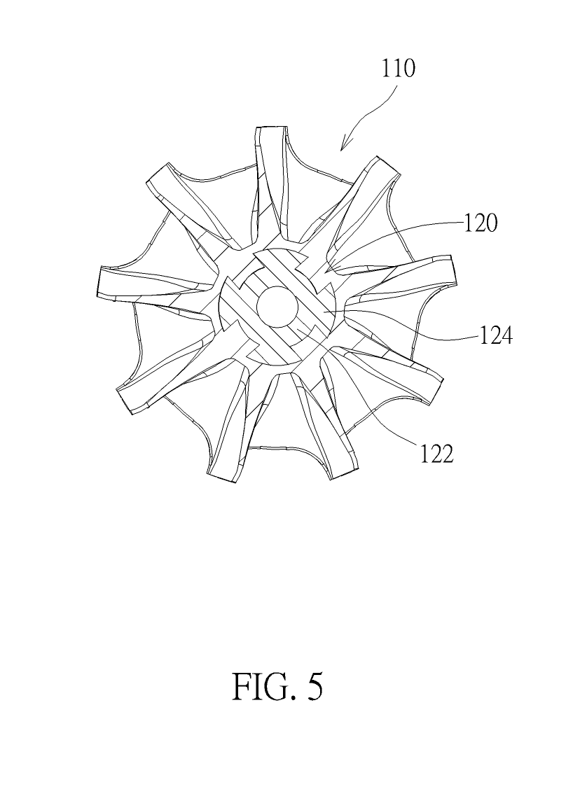

Please refer to FIG. 5, and FIG. 3 as well. FIG. 5 is a cross-sectional view of combination of the turbine wheel and the connection element of the present invention. As shown in FIG. 3, when the turbine wheel 110 is combined with the connection element 120, the engaging structure 124 of the connection element 120 prevents the connection element 120 from moving along a rotational axis of the turbo rotor 100 relative to the turbine wheel 110. In addition, as shown in FIG. 5, when the turbine wheel 110 is combined with the connection element 120, the engaging structure 124 of the connection element 120 also prevents the connection element 120 from rotating around the rotational axis of the turbo rotor 100 relative to the turbine wheel 110. On the other hand, since a surface of the connection element 120 is fit to a surface of the cavity 114, the connection element 120 is prevented from moving along other directions or rotating around other axis relative to the turbine wheel 110. In other words, the connection element 120 is completely fixed to the turbine wheel 110.

According to the above arrangement, when manufacturing the turbo rotor 100 of the present invention, since the connection element 120 is fixed to the turbine wheel 110 through the engaging structure 124, it is not necessary to consider whether a material of the connection element 120 can be welded to a material of the turbine wheel 110. It is only required to consider whether the material of the connection element 120 can be welded to a material of the rotor shaft 130, so as to increase flexibility in material selection. In addition, since the connection element 120 is stably fixed to the turbine wheel 110 through the engaging structure 124, bonding strength between the connection element 120 and the turbine wheel 110 is greater than bonding strength between weld-bonded components in the prior art. Therefore, the turbo rotor 100 of the present invention has better product stability. In addition, quantities of the engaging structures 124 and the fixing structures 116 of the present invention are not limited to the above embodiment. The turbo rotor 100 of the present invention can comprise at least one engaging structure 124 and at least one fixing structure 116 to achieve the same purpose.

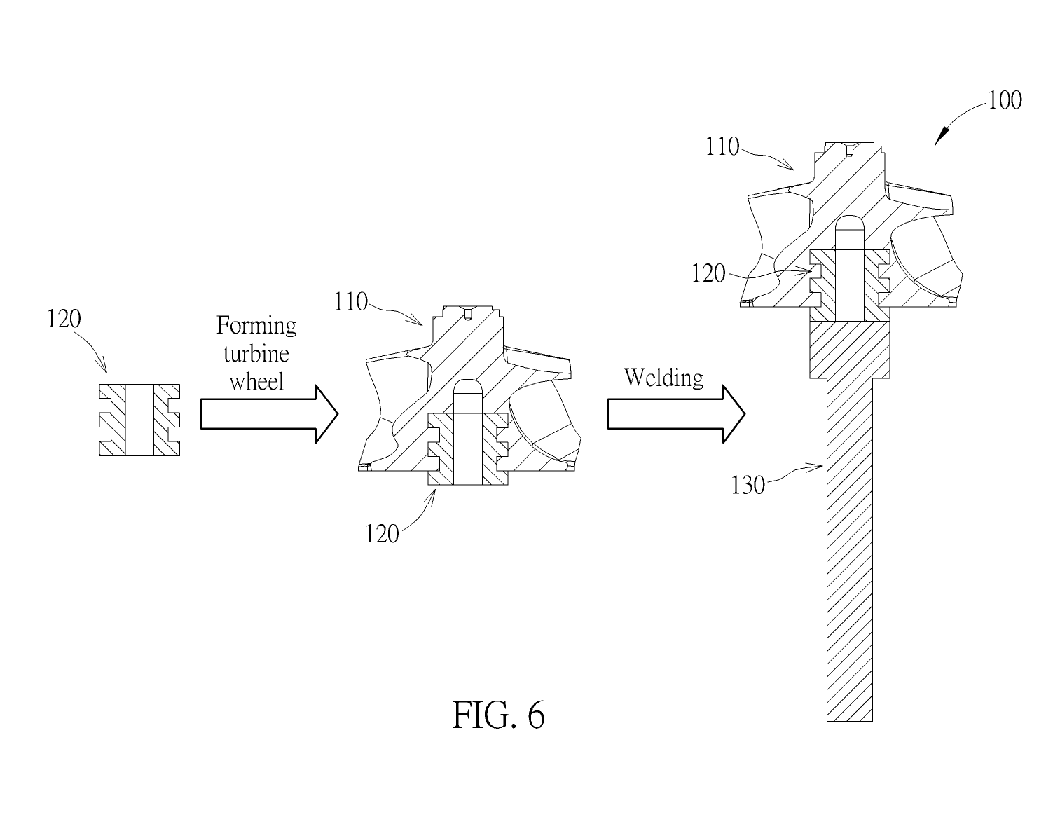

Please refer to FIG. 6, and FIG. 4 as well. FIG. 6 is a diagram illustrating a manufacturing method of the turbo rotor of the present invention. As shown in FIG. 6, the connection element 120 can be provided first in the manufacturing method of the turbo rotor of the present invention. Thereafter, the connection element 120 is directly covered by the turbine wheel 110 during formation of the turbine wheel 110. For example, the turbine wheel 110 can be formed by metal injection molding, lost wax casting or other related molding techniques, and the connection element 120 can be seen as a part of a mold for forming the turbine wheel 110. Therefore, when forming the turbine wheel 110, the cavity 114 of the turbine wheel 110 and the fixing structure 116 are formed simultaneously. In addition, profiles of the cavity 114 and the fixing structures 116 fit with the surface of the connection element 120, such that the connection element 120 can be stably fixed to the turbine wheel 110. Finally, the rotor shaft 130 is connected to the main body 122 of the connection element 120 by welding for forming the turbo rotor 100 of the present invention. The material of the connection element 120 can be selected from materials which are easy to be welded to the material of the rotor shaft 130.

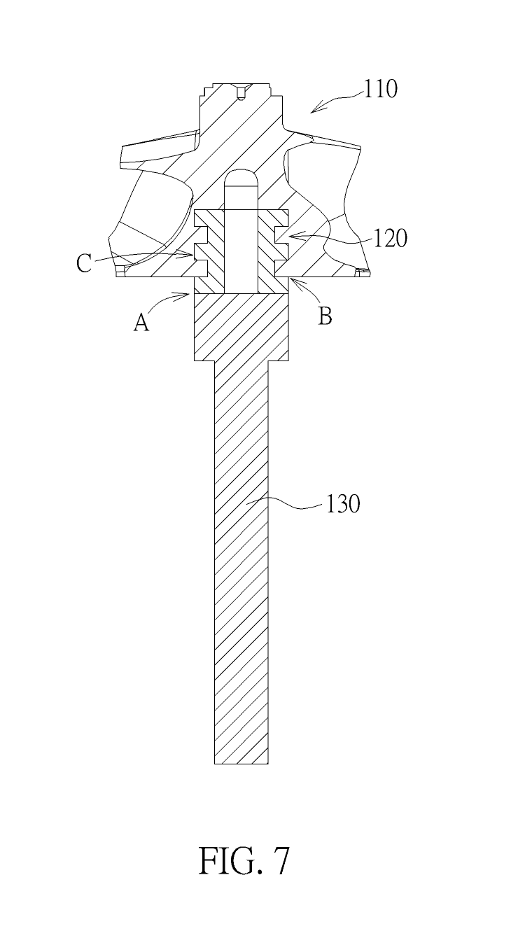

Please refer to FIG. 7. FIG. 7 is a diagram illustrating a welding process of the turbo rotor according to a first embodiment of the present invention. As shown in FIG. 7, the connection element 120 can be formed by a proper welding material, such that the rotor shaft 130 can directly contact the connection element 120 to perform welding (such as friction welding or electron beam welding) at a contact position A. The manufacturing method of the present embodiment can use a horizontal welding machine to weld the rotor shaft 130 to the connection element 120 by friction welding. Or, the manufacturing method of the present embodiment can use a horizontal welding machine or a vertical welding machine to weld the rotor shaft 130 to the connection element 120 by electron beam welding. In addition, the manufacturing method of the present embodiment can also use the horizontal welding machine or the vertical welding machine to weld the connection element 120 to the turbine wheel 110 at a contact position B and/or a contact position C by electron beam welding, such that the bonding strength between the connection element 120 and the turbine wheel 110 can be further increased.

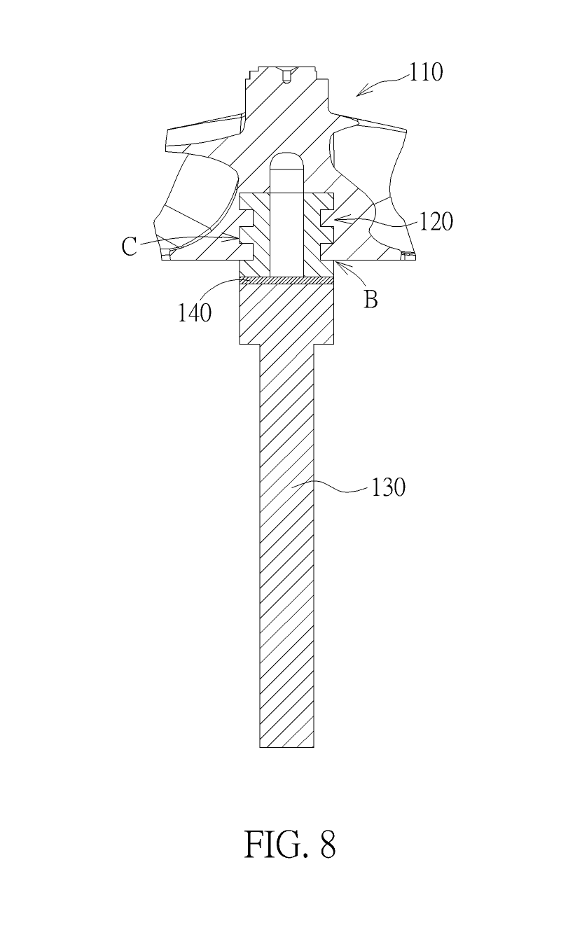

Please refer to FIG. 8. FIG. 8 is a diagram illustrating a welding process of the turbo rotor according to a second embodiment of the present invention. As shown in FIG. 8, a layer of welding material 140 can be arranged between the rotor shaft 130 and the connection element 120 for welding (such as brazing) the rotor shaft 130 to the connection element 120. Similarly, the manufacturing method of the present embodiment can also use the horizontal welding machine or the vertical welding machine to weld the connection element 120 to the turbine wheel 110 at the contact position B and/or the contact position C by electron beam welding, such that the bonding strength between the connection element 120 and the turbine wheel 110 can be further increased.

On the other hand, since the main body 122 of the connection element 120 has a through hole 126, a hollow part can be formed in the cavity 114 without being fully filled during the formation of the turbine wheel 110, and the through hole 126 of the connection element 120 is communicated with the remaining hollow part of the cavity 114. Therefore, a total weight of the turbo rotor 100 of the present invention can be further reduced, so as to increase efficiency of a turbo charger and reduce turbo lag.

Moreover, the manufacturing method of the turbo rotor of the present invention is not limited to the embodiment of FIG. 6. In other embodiment of the present invention, the turbine wheel 110 can be formed first. Thereafter, the connection element 120 can be formed directly in the cavity 114 of the turbine wheel 110. For example, the connection element 120 can be formed by metal injection molding, lost wax casting or other related molding techniques, and the turbine wheel 110 can be seen as a part of a mold for forming the connection element 120. Therefore, when forming the connection element 120, the engaging structures 124 of the connection element 120 are formed simultaneously. In addition, profiles of the cavity 114 and the fixing structures 116 fit with the surface of the connection element 120, such that the connection element 120 can be stably fixed to the turbine wheel 110.

Similarly, since the main body 122 of the connection element 120 has a through hole 126, a hollow part can be formed in the cavity 114 without being fully filled during the formation of the connection element 120, and the through hole 126 of the connection element 120 is communicated with the remaining hollow part of the cavity 114. Therefore, the total weight of the turbo rotor 100 of the present invention can be further reduced, so as to increase efficiency of the turbo charger and reduce turbo lag.

In other embodiments of the present invention, the turbine wheel 110 and the connection element 120 can be formed in a same process by bi-metallic metal injection molding, in order to increase production efficiency.

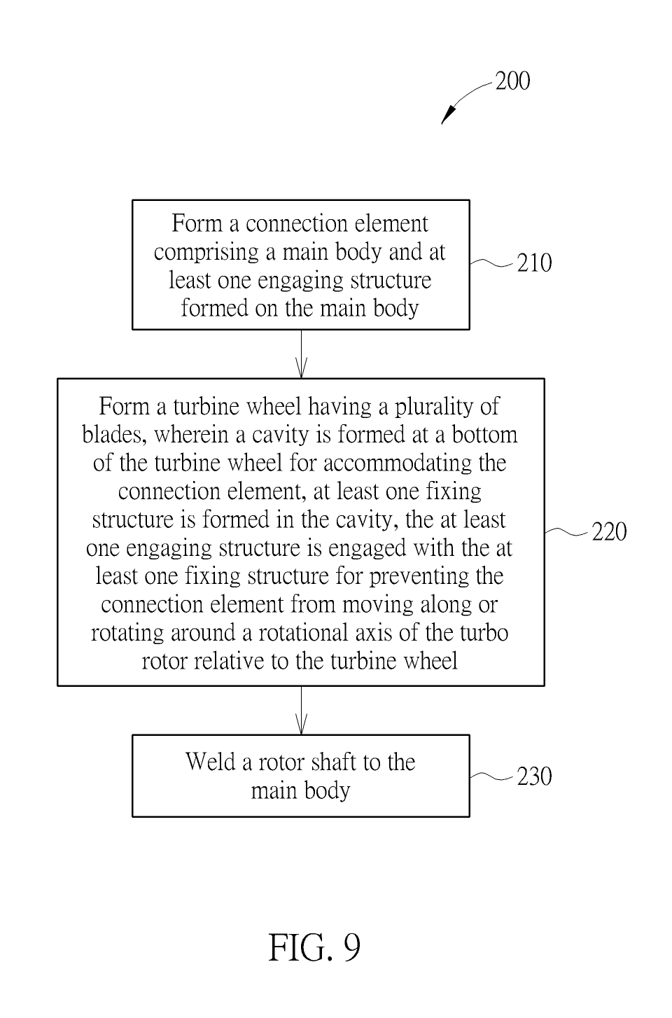

Please refer to FIG. 9. FIG. 9 is a flowchart 200 showing the manufacturing method of the turbo rotor of the present invention. The flowchart of the manufacturing method of the turbo rotor comprises the following steps:

Step 210: Form a connection element comprising a main body and at least one engaging structure formed on the main body;

Step 220: Form a turbine wheel having a plurality of blades, wherein a cavity is formed at a bottom of the turbine wheel for accommodating the connection element, at least one fixing structure is formed in the cavity, the at least one engaging structure is engaged with the at least one fixing structure for preventing the connection element from moving along or rotating around a rotational axis of the turbo rotor relative to the turbine wheel; and

Step 230: Weld a rotor shaft to the main body.

In addition, to achieve the same result, the steps of the flowchart 200 need not be in the exact order shown and need not be contiguous, that is, other steps can be intermediate.

In contrast to the prior art, the turbo rotor of the present invention comprises the connection element being fixed to the turbine wheel through the engaging structures, and the rotor shaft is welded to the connection element. Thus it is not necessary to consider whether the material of the connection element can be welded to the material of the turbine wheel, so as to increase flexibility in material selection. Moreover, since the bonding strength between the connection element and the turbine wheel 110 is greater than the bonding strength between weld-bonded components in the prior art, the turbo rotor of the present invention has better product stability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A turbo rotor, comprising:
a turbine wheel having a plurality of blades, wherein a cavity is formed at a bottom of the turbine wheel, and at least one fixing structure is formed in the cavity;
a connection element accommodated in the cavity, the connection element comprising:
a main body; and
at least one engaging structure formed on the main body,
wherein the at least one engaging structure is engaged with the at least one fixing structure for preventing the connection element from moving along or rotating around a rotational axis of the turbo rotor relative to the turbine wheel; and
a rotor shaft connected to the main body for supporting the turbine wheel.

2. The turbo rotor of claim 1, wherein the at least one engaging structure is protruded from the main body.

3. The turbo rotor of claim 1, wherein the at least one engaging structure is recessed from a surface of the main body.

4. The turbo rotor of claim 1, wherein a through hole is formed on the main body to communicate with the cavity.

5. A manufacturing method of a turbo rotor, comprising:
forming a connection element comprising a main body and at least one engaging structure formed on the main body;
forming a turbine wheel having a plurality of blades, wherein a cavity is formed at a bottom of the turbine wheel for accommodating the connection element, at least one fixing structure is formed in the cavity, the at least one engaging structure is engaged with the at least one fixing structure for preventing the connection element from moving along or rotating around a rotational axis of the turbo rotor relative to the turbine wheel; and
welding a rotor shaft to the main body.

6. The manufacturing method of claim 5, wherein the connection element is covered by the turbine wheel during formation of the turbine wheel.

7. The manufacturing method of claim 5, wherein the connection element is formed directly in the cavity.

8. The manufacturing method of claim 5, wherein the at least one engaging structure is protruded from the main body.

9. The manufacturing method of claim 5, wherein the at least one engaging structure is recessed from a surface of the main body.

10. The manufacturing method of claim 5, wherein a through hole is formed on the main body to communicate with the cavity.

11. The manufacturing method of claim 5, wherein the rotor shaft is directly welded to the main body.

12. The manufacturing method of claim 5, wherein the rotor shaft is welded to the main body through a welding material.
